(19) United States
(12) Patent Application Publication
(10) Pub. No.: US 2010/0203853 A1
(43) Pub. Date: Aug. 12, 2010

(54) USAGE FREQUENCY DETERMINING DEVICE AND TRANSMITTING DEVICE

(75) Inventors: Tadahiro Makabe, Gunma-ken (JP); Satoshi Terada, Paramus, NJ (US); Masaki Kinoshita, Ridgewood, NJ (US)

Correspondence Address: OSHA LIANG L.L.P., TWO HOUSTON CENTER, 909 FANNIN, SUITE 3500, HOUSTON, TX, 77010, US

(73) Assignees: Sanyo Electric Co., Ltd., Osaka (JP); Sanyo Semiconductor Co., Ltd, Ora-Gun (JP)

(21) Appl. No.: 12/369,348

(22) Filed: Feb. 11, 2009

(51) Int. Cl. H04B 17/00

(52) U.S. Cl. 455/115.1; 455/226.1

(57) ABSTRACT

Current position information is acquired based on input by an inputting device. An available frequency memory stores, for each region, data regarding an available frequency that is not used for broadcasting from a broadcasting station. A usage frequency is determined based on the current position information and on the available frequency at the current position acquired referring to the data of the available frequency memory.

### BACKGROUND OF THE INVENTION

1. Field of the Invention

The present invention relates to a usage frequency determining device which determines a transmission frequency of an FM signal or the like and to a transmitting device which transmits the signal.

2. Description of the Related Art

Conventionally, a transmitting device which is called an FM transmitter is known. For example, the FM transmitter allows transmission of sounds of a portable player such as a music player having a built-in hard disk drive, a semiconductor memory player, and a portable MD/CD player using FM electric waves, and replay of the sounds using an FM radio tuner or the like. Therefore, by equipping the FM transmitter in an earphone terminal of the portable player, the sound replayed by the portable player can be replayed with a stationary player, an FM radio, an FM tuner equipped in an automobile, etc.

In an FM transmitter, a frequency band which is not used in a normal FM broadcasting must be selected as the usage frequency band. Therefore, an FM receiver has been equipped to determine whether or not the FM broadcasting wave is present in the corresponding frequency and an available frequency in which no broadcasting wave exists has been set as the transmission frequency.

JP8-140155A, JP2005-286711A, etc. describe the FM receiver.

However, the operation to find an available frequency with an FM receiver requires a long time. For example, there is a possibility of presence of a broadcasting station at every 100 kHz in Japan and every 50 kHz in the United States, and thus checking for an available frequency by scanning the entire frequency band of the broadcasting waves in a range of approximately 15 MHz to 20 MHz requires a long period of time.

### SUMMARY OF THE INVENTION

According to one aspect of the present invention, an available frequency at a current position is identified using data of available frequencies in each region which is stored in an available frequency memory.

### BRIEF DESCRIPTION OF THE DRAWINGS

A preferred embodiment of the present invention will be described in detail by reference to the drawings, wherein:

FIG. 1 is a diagram showing a structure of an FM transmitting device according to a preferred embodiment of the present invention.

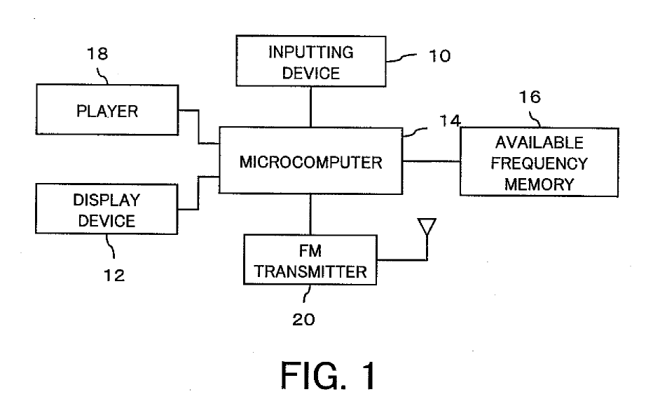

### DESCRIPTION OF THE PREFERRED EMBODIMENT

A preferred embodiment of the present invention will now be described with reference to the drawing.

An inputting device 10 which functions as a current position acquiring device is provided for inputting current position information, and may be formed with various devices. For example, the inputting device 10 may be formed with a numerical pad or the like and a zip code, a phone number (area code), etc. may be input. Alternatively, the name of the city or an address may be directly input. Alternatively, it is also possible to form the inputting device 10 with a GPS device or the like and detect the current position. The GPS device detects the current position by receiving electric waves from a plurality of artificial satellites, and is equipped in various devices. In addition, in many cases an automobile is equipped with a navigation device, and in such cases, the current position is detected using the GPS device or various communication devices. Thus, the current position information may be acquired from the navigation device. In addition, if the inputting device 10 is formed with a voice recognition device, the name of the city or the like can be input with voice. Moreover, in the present embodiment, a display device 12 is provided. It is therefore possible to form the inputting device 10 with a touch panel on a front surface of the display device 12. In a touch panel, the current position can be input in various manners such as, for example, selection from a map display. Moreover, with the touch panel, the inputting of the text and numbers may be executed by selection on the screen.

The inputting device 10 and the display device 12 are connected to a microcomputer 14. The microcomputer 14 executes various processes in addition to processing of input data from the inputting device 10.

An available frequency memory 16 is connected to the microcomputer 14. The available frequency memory 16 stores, for each region, data regarding an available frequency in which there is no broadcasting station. More specifically, as described above, the broadcasting stations avoid interference by using only the predetermined frequency in every 100 kHz or every 50 kHz. Thus, if there is no broadcasting station in a frequency in which a broadcasting station can exist, it is preferable to execute the low power FM communication using that frequency, and the available frequency memory 16 stores such usable frequencies for each region. The microcomputer 14 identifies the region according to current position data from the inputting device 10 and reads the available frequency for the region from the available frequency memory 16, so that the available frequency at the current position can be detected.

A player 18 is connected to the microcomputer 14. The player 18 is a portable player such as a music player having a built-in hard disk drive, a semiconductor memory player, and a portable MD/CD player, and either does not have a speaker or has a low performance speaker. Therefore, music or the like is typically replayed through earphones.

An FM transmitter 20 is connected to the microcomputer 14. The FM transmitter 20 receives a replay signal which is replayed in the player 18, FM-modulates the signal, and transmits. During this process, as a frequency of the carrier, a frequency determined by the microcomputer 14 based on the data from the available frequency memory 16 is used. In other words, by the microcomputer 14 reading, from the available frequency memory 16, an available frequency in which there is no broadcasting station and transmitting the read frequency to the FM transmitter 20, the transmission frequency of the FM transmitter 20 is set at the available frequency.

In this manner, in the present embodiment, the current position is input by the inputting device 10. Therefore, even when the device is equipped on a vehicle and is moved, the current position can be identified. The microcomputer 14 then searches through available frequency data in the available frequency memory 16 using the current position as a key, acquires a frequency in which there is no broadcasting station at the current position, and supplies the frequency to the FM transmitter 20 as the usage frequency. The FM transmitter 20 can therefore set the transmission frequency at the available frequency and transmit the signal from the player 18. Thus, at the FM radio, the reception frequency can be set to the transmission frequency of the FM transmitter 20 so that the music or the like which is replayed by the player 18 can be output from the speaker of the FM radio.

In many cases, there are a plurality of available frequencies in one region. The microcomputer 14 sequentially selects the available frequency from among the plurality of available frequencies using a predetermined method such as a decreasing order, an increasing order, a random order, etc., sets the transmission frequency of the FM transmitter 20, and displays the transmission frequency on the display device 12. With this process, the user can tune the transmission frequency of the FM radio to the displayed transmission frequency. In this state, confirmation is requested, on the display device 12, as to whether or not this frequency is acceptable and a request for change to the next frequency is accepted at the inputting device 10. In this manner, the transmission frequency of the FM transmitter 20 is set to a transmission frequency preferred by the user. The microcomputer 14 may sequentially set different frequencies for to the plurality of available frequencies, and may learn the preferences such as removing frequencies from the next selection candidates if the user has input change to the frequency, or the number of such changes is large.

In the present embodiment, data of the available frequencies for each region are stored in the available frequency memory 16 in advance. For example, in the United States, the frequencies of the broadcasting stations for each region are publicized as data, and such data may be stored. The frequencies of the broadcasting stations may be stored in the available frequency memory 16 and the microcomputer 14 may select a frequency in which there is no broadcasting station, or, alternatively, the available frequencies may be stored in advance. It is preferable to form the available frequency memory 16 with a flash memory or the like and the data is stored in the available frequency memory 16 in advance in the factory before shipping. Then, in response to the input by the user indicating that the frequency is not suitable, the microcomputer may learn the unusability of the frequency.

Alternatively, a rewrite mode of the available frequency memory 16 may be prepared, and the rewriting of the contents of the available frequency memory 16 by the user may be allowed.

What is claimed is:

1. A usage frequency determining device comprising:
an acquisition unit which acquires current position information;
an available frequency memory which stores, for each region, data of an available frequency that is not used for broadcasting from a broadcasting station; and
a usage frequency determining unit which determines, based on the current position information acquired by the acquisition unit, a usage frequency based on an available frequency at a current position acquired referring to the data of the available frequency memory.

2. A transmitting device, comprising:
an acquisition unit which acquires current position information;
an available frequency memory which stores, for each region, data of an available frequency that is not used for broadcasting by a broadcasting station;
a usage frequency determining unit which determines, based on the current position information acquired by the acquisition unit, a usage frequency based on an available frequency at a current position acquired referring to the data of the available frequency memory; and
a transmitting unit which transmits a signal using the determined usage frequency.

3. The transmitting device according to claim 2, wherein
the transmitting unit transmits an FM signal and the transmitted signal can be received by an FM radio.

4. The transmitting device according to claim 2, wherein
the acquisition unit is an inputting device which accepts data related to the current position by input of a user.

5. The transmitting device according to claim 3, wherein
the acquisition unit is an inputting device which accepts data related to the current position by input of a user.

6. The transmitting device according to claim 2, wherein
the acquisition unit is a GPS device which detects the current position.

7. The transmitting device according to claim 3, wherein
the acquisition unit is a GPS device which detects the current position.
